(19) United States
(12) Patent Application Publication
(10) Pub. No.: US 2003/0148654 A1
(43) Pub. Date: Aug. 7, 2003

(54) Structure improvement for connection seat

(76) Inventor: Chin-Mao Kan, Tao Yuan (TW)

Correspondence Address: BRUCE H. TROXELL, SUITE 1404, 5205 LEESBURG PIKE, FALLS CHURCH, VA, 22041, US

(21) Appl. No.: 10/066,613

(22) Filed: Feb. 6, 2002

(51) Int. Cl. H01R 3/00

(52) U.S. Cl. 439/490

(57) ABSTRACT

A structure improvement for connection seat, which is mainly comprised of a main body and a guiding needle seat, wherein the front end of the main body has an opening, and at least one LED accommodation groove is arranged at an appropriate position of the front end of the main body, and cut grooves provided for inserting and fixing the guiding needle seat are arranged at the back face and bottom seat of the main body and, in addition, the guiding needle seat is formed as L-shape, and several guiding needles are arranged at the portion of horizontal plate of the front end of the guiding needle seat, and plural penetration holes are arranged at an appropriate position of the vertical plate of the guiding needle seat for providing the contact legs of the LED to be inserted into. During assembling, the producer may insert the contact legs of the LED directly into the penetration holes arranged at the vertical plate of the guiding needle seat, and project them out the bottom face of the vertical plate, and bend the upper portion of the LED forward by the machine tool and, finally, insert the guiding needle seat arranged with LED and guiding needles 211 from the rear portion of the main body into the main body and to be fixed therein to make the LED and the guiding needle be able to be inserted quickly into the LED accommodation groove and the cut grooves arranged on the main body to be fixed therein. By the aforementioned structure, the contact legs of the LED may be completely covered and hidden in the vertical plate of the guiding needle seat to be secured surely therein, so the production may be raised effectively and the manufacture cost is also lowered down and, in the mean time, not only is the outer appearance more beautiful, but also may the situations of short circuit and signal interference of the shortcomings of the prior arts be solved, and the quality of the product can be promoted greatly to fulfill the object of practical application.

### 1. FIELD OF THE INVENTION

The invention relates to a structure improvement for connection seat, particularly to a structure improvement for connection seat that may be manufactured simply and may avoid the incurrence of situations of short circuit and signal interference.

### 2. BACKGROUND OF THE INVENTION

Accordingly, following the prompt progress and development of high technologies, various information products are developed continuously, not only is the living of mankind further comfortable, but also is the distance between people shrunk greatly due to the transferring speed of information being increased quickly. The connection seats and the connection lines are all needed for the connections between any kind of information devices to achieve the object of information transfer. Wherein, the application of connection seat responsible for the connection and transfer in the internet is most popular and its application of relative products is also most diversified and, for example, internet card, hub, or IP sharer, etc. all apply these connection seat and connection head for achieving the object of connection between electric appliances and, just for hub, there are divisions of 5 ports, 8 ports, 16 ports, and 24 ports and, therefore, the usage amount of the connection seat is very great, and in order to facilitate the user to understand if the connection head and the connection seat are connected accurately or the connection line works normally, so most current connection seat is adapted with a LED. The connection seat with LED according to the prior arts (as shown in FIG. 1) is mainly comprised of a main body A, and an opening B is arranged at the front end of the main body A, and several guiding needles C are also arranged at the inner face under the main body A. Further, there are LED accommodation grooves D arranged respectively at the upper two sides of the front end of the main body A, and penetration holes F arranged at the position of the back face of the main body A corresponding to the LED accommodation grooves D are provided for the contact legs E of the LED to penetrate through. In addition, there is at least one recessing groove G arranged at the back face of the main body A, and plural connection structures H are arranged at the recessing groove G. By the aforementioned design, when the LED is going to be arranged in the LED connection seat, the LED must be inserted into the LED accommodation groove D arranged at the front end of the main body to make the contact legs E penetrate through the penetration holes F arranged at the back face of the main body A and, finally, the LED contact legs E projected out the back face of the main body A are bent into the recessing groove G arranged at the back face of the main body A, and the contact legs E are connected and fixed by the connection structure H arranged on the recessing groove G to complete the assembly. Although the aforementioned structure according to the prior arts may arrange the LED on the main body, but the LED connection seat of prior arts still has several shortcomings during the procedures of actual manufacture assembly and application. First, since the distance between the penetration hole F arranged at the back face of the main body A and the front end of the main body A is quite long and the contact leg E of LED is going to be bent, so it is not easy for inserting the LED into the LED accommodation groove D arranged at the front end of the main body A and then making the LED contact leg E penetrate through the penetration hole F arranged at the back face of the main body A during the actual procedure of assembly. In addition, since the LED portion is arranged after the main body being completed, so it is difficult to bend the LED contact legs E. An arc angle with elastic force is generated because the LED contact legs E can not be bent completely. On the other hand, even a machine tool is applied to bend the contact legs E, it has to manufacture various machine tools adapted for respectively bending 5 pieces, 8 pieces, 16 pieces, and 24 pieces of contact legs on the LED connection seat. This kind of structure not only increases the manufacture cost, but also creates a lot of inconvenience. Since the LED connection seat is still a kind of simple structure, so its price is very competitive under the situation of mass production. Besides, any added cost in the prior structure will influence and lower down the competition ability of this product in current market. Furthermore, the LED contact legs E of the prior LED connection seat are bent and secured in the recessing groove G arranged at the back face of the main body A, and connected and secured by the connection structure H thereon. However, for this kind of design, not only are the LED contact legs E exposed outside without the beautiful outer appearance, neither can the contact legs E be bent completely, and an arc angle with elasticity is formed. Therefore, although the contact legs E of LED are connected and secured by the connection structure H, but it still can not guarantee that the contact legs E will be loose from the connection structure H in the future due to the elastic force or other influencing factors of external forces, and a situation of short circuit and signal interference would be further incurred.

According to the description described thereinbefore, it is obvious that the LED connection seat of the prior arts not only is tedious to manufacture, but also the LED contact legs are exposed outside, and the situations of unstable qualities are easily incurred, such as short circuit or signal interference, etc., and these kinds of shortcomings are urgently needed to be improved.

In order to improve the all shortcomings generated from the products according to the prior arts described thereinbefore, the inventor, with years' experience and research concentrated on this relative products and through continuous devotion, experimental analysis plus improvement, has finally proposed a reasonable design of invention that may effectively solve the shortcomings of the prior arts.

### SUMMARY OF THE INVENTION

The main object of the invention is to provide a structure improvement for connection seat, which is mainly comprised of a main body and a guiding needle seat. Wherein the front end of the main body has an opening, and at least one LED accommodation groove is arranged at an appropriate position of the front end of the main body, and cut grooves provided for inserting and fixing the guiding needle seat are arranged at the back face and bottom seat of the main body and, in addition, the guiding needle seat is formed as L-shape, and several guiding needles are arranged at the portion of horizontal plate of the front end of the guiding needle seat, and plural penetration holes are arranged at an appropriate position of the vertical plate of the guiding needle seat for providing the contact legs of the LED to be inserted into. According to structure described thereinbefore, the producer may insert the contact legs of the LED directly into the penetration holes arranged at the vertical plate of the guiding needle seat, and project them out the bottom face of the vertical plate, and bend the upper portion of the LED forward by the machine tool and, finally, insert the guiding needle seat arranged with LED and guiding needles from the rear portion of the main body into the main body and to be fixed therein to make the LED and the guiding needle be able to be inserted quickly into the LED accommodation groove and the cut grooves arranged on the main body to be fixed therein. By the aforementioned structure, the contact legs of the LED may be completely covered and hidden in the vertical plate of the guiding needle seat to be secured surely therein, so the production may be raised effectively and the manufacture cost is also lowered down and, in the mean time, not only is the outer appearance more beautiful, but also may the situations of short circuit and signal interference of the shortcomings of the prior arts be solved, and the quality of the product can be promoted greatly.

The secondary object of the invention is to provide a structure improvement for connection seat wherein, since the penetration holes that are located at the vertical plate of the guiding needle seat and are provided for the LED contact legs to be inserted into are visible, so it is more convenient and quicker than the prior arts to insert the LED contact legs into the penetration holes.

Another object of the invention is to provide a structure improvement for connection seat wherein, since the LED is bent and fixed in the guiding needle seat in advance, so the producer can align multi-number of guiding needle seat in advance, then proceed the bending work on entire row of guiding needle seat with a machine tool. Not only may the production amount be increased greatly to lower down the production and manufacture cost, but also may a better effect of bending work be obtained.

Further object of the invention is to provide a structure improvement for connection seat, wherein a recessing groove that is arranged at the front end of the penetration hole at the top end of the fixation plate of the guiding needle seat is provided for accommodating LED contact leg and, after the upper end of LED is bent forward, the LED contact leg may be positioned in the recessing groove and, thereby a better effect of bending work is obtained.

For your esteemed committee member to further understand and recognize the structural object and function of the present invention, a detailed description in cooperation with corresponding drawings are presented as follows.

### BRIEF DESCRIPTION OF THE DRAWINGS

FIG. 1A and FIG. 1B are the outer three-dimensional views for the prior structure.

FIG. 2 is a three-dimensional outer view for the present invention.

FIG. 3 is a three-dimensional explosive view for the present invention.

FIG. 4 is a cross-sectional illustration for the present invention.

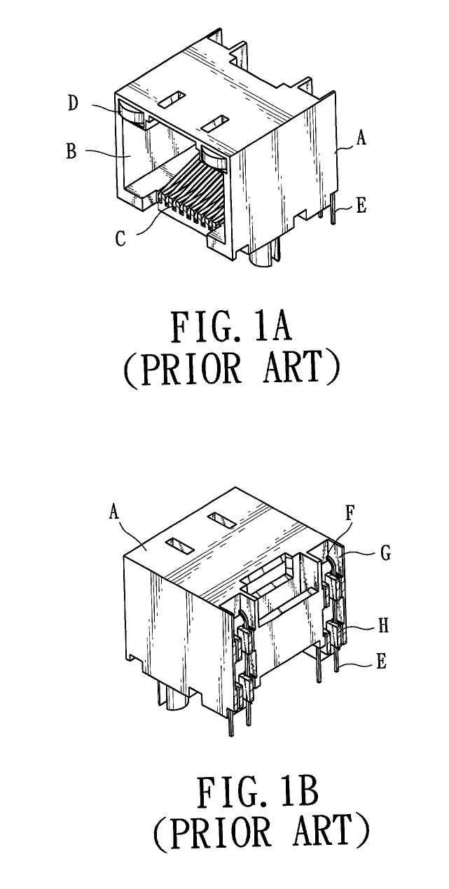

### DETAILED DESCRIPTION OF THE INVENTION

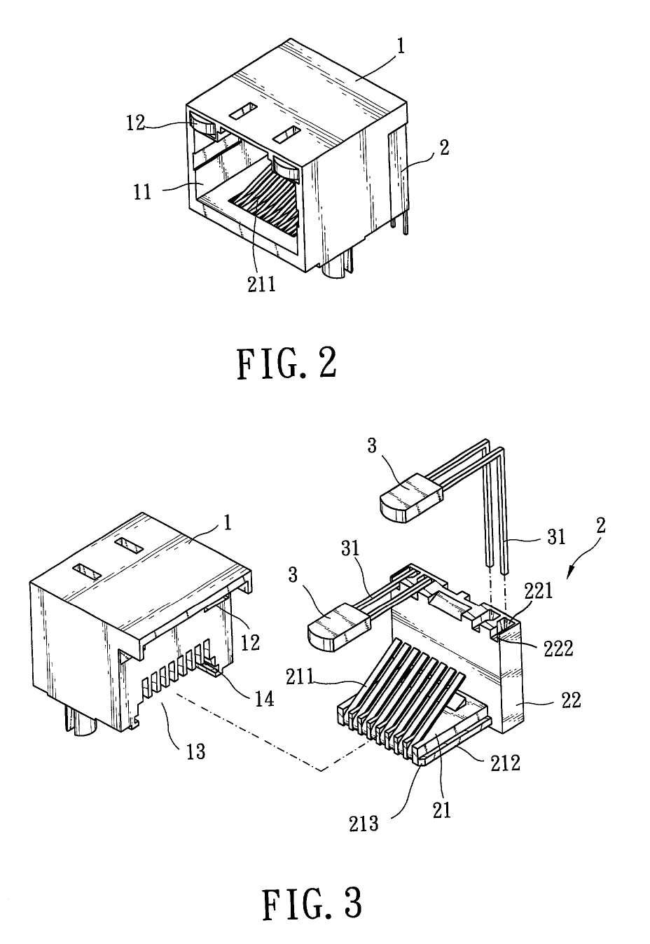

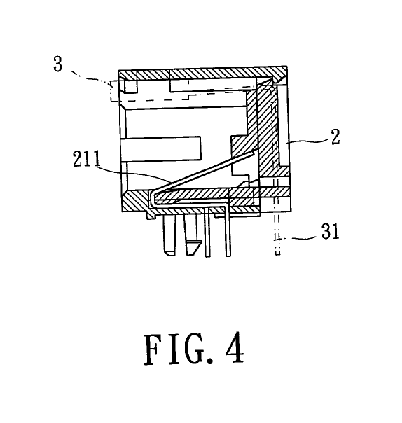

First, please refer to FIG. 2 and FIG. 3, which are the three-dimensional view and the three-dimensional explosive view for the structure improvement for the connection seat. The structure improvement for the connection seat disclosed in the invention is mainly comprised of a main body 1 and a guiding needle seat 2. Wherein the front end of the main body 1 has an opening 11, and at least one LED accommodation groove 12 is arranged at an appropriate position of the front end of the main body 1, and cut grooves 13 provided for inserting and fixing the guiding needle seat 2 are arranged at the back face and bottom seat of the main body 1 and, in addition, the guiding needle seat 2 is formed as L-shape, and several guiding needles 211 are arranged at the portion of horizontal plate 21 of the front end of the guiding needle seat 2, and plural penetration holes 221 are arranged at an appropriate position of the vertical plate 22 of the guiding needle seat 2 for providing the contact legs 31 of the LED 3 to be inserted into. According to structure described thereinbefore, the producer may insert the contact legs 31 of the LED 3 directly into the penetration holes 221 arranged at the vertical plate 22 of the guiding needle seat 2, and project them out the bottom face of the vertical plate 22, and bend the upper portion of the LED 3 forward by the machine tool and, finally, insert the guiding needle seat 2 arranged with LED 3 and guiding needles 211 from the rear portion of the main body 1 into the main body 1 and to be fixed therein (as shown in FIG. 4) to make the LED 3 and the guiding needle 211 be able to be inserted quickly into the LED accommodation groove 12 and the cut grooves 13 arranged on the main body to be fixed therein. By the aforementioned structure, the contact legs 31 of the LED 3 may be completely covered and hidden in the vertical plate 22 of the guiding needle seat 2 to be secured surely, so the production may be raised effectively and the manufacture cost is also lowered down and, in the mean time, not only is the outer appearance more beautiful, but also may the situations of short circuit and signal interference of the shortcomings of the prior arts be solved, and the quality of the product can be promoted greatly.

Further, in the structure described thereinbefore, since the penetration holes 221 that are located at the vertical plate 22 of the guiding needle seat 2 and are provided for the LED contact legs 31 to be inserted into are visible, so it is more convenient and quicker than the prior arts to insert the LED contact legs 31 into the penetration holes 211.

A position mechanism is further included between the main body 1 and the guiding needle seat 2 according to the invention to make both connected in more accurate way. The position mechanism is mainly arranged a flange 212 respectively on the two sides (i.e., the left side and the right side) of the horizontal plate 21 of the guiding needle seat 2. In the mean time, a guiding groove 14 capable of accommodating aforementioned flange 212 is arranged in the main body 1 at an appropriate position corresponding to the aforementioned flange 212. By the aforementioned structure, the guiding needle seat 2 of the invention may be inserted into the guiding groove 14 arranged on the main body 1 to reach the effect of position by applying the flange 212 arranged respectively on the two sides (i.e., the left side and the right side) of the horizontal plate 21. Again, an incline guiding angle 213 is further arranged at the front end of said flange 212 arranged respectively on the two sides (i.e., the left side and the right side) of the horizontal plate 21 of the guiding needle seat 2 and, thereby, the flange 212 may be inserted quickly into the guiding groove 14 arranged inside the main body 1.

Again, according to the invention, since the LED 3 is bent and fixed on the guiding needle seat 2 in advance, so the producer can align plural guiding needle seat 2 in advance, then proceed the bending work on the entire row of guiding needle seat 2 directly and, not only may the production amount be promoted greatly, but also may the production and manufacture cost be lowered down and, therefore a better effect of bending work may be obtained. On the other hand, a complete product is obtained after the main body 1 and the guiding needle seat 2 are assembled, and no more process is needed. Therefore, it does not matter if the invention applied in the products is belonged to 5 ports, 8 ports, 16 ports, or 24 ports, it still can be placed into use directly without preparing any additional machine tool for process.

Again, a recessing groove 222 capable of accommodating LED contact legs 31 is arranged at the front edge of the penetration hole 221 at the top end of the vertical plate 22 of the guiding needle seat 2 according to the invention. After the upper portion of the LED 3 is bent forward, the LED contact leg 31 may be positioned in the recessing groove 222 and, thereby, a better effect of bending work is obtained.

Above description is the preferable embodiment according to the invention. However, the range covered by the invention is not restricted to the described embodiment. Any variation that relates to the contents of the invention to generate the function and characteristic similar to those of the invention or may be conceived out by those who are skilled in this art is all covered within the range of the invention. For example, the LED mentioned in this invention may also be changed to another electronic components.

In summary, the structure improvement for connection seat according to the invention has the characteristics of simple structure and easy manufacture. Compared to the prior products, the invention not only has the merits of quick assembly and easy manufacture, but also it is adapted for mass production for lowering down the manufacture cost and increasing the market competition abilities. On the other hand, the invention may cover the entire LED contact legs in the interior. Not only is the outer appearance of the product beautiful, but also may the situations of short circuit or signal interference be prevented and, thereby, the quality of the product is promoted.

What is claimed is:

1. A structure improvement for connection seat, which is mainly comprised of a main body and a guiding needle seat, wherein the front end of the main body has an opening, and at least one LED accommodation groove is arranged at an appropriate position of the front end of the main body, and cut grooves provided for inserting and fixing the guiding needle seat are arranged at the back face and bottom seat of the main body and, in addition, the guiding needle seat is formed as L-shape, and several guiding needles are arranged at the portion of horizontal plate of the front end of the guiding needle seat, and plural penetration holes are arranged at an appropriate position of the vertical plate of the guiding needle seat for providing the contact legs of the LED to be inserted and hidden therein.

2. The structure improvement for connection seat according to claim 1, wherein a position mechanism is further included between the main body and the guiding needle seat, and the position mechanism is mainly comprised of two flanges arranged respectively on the two sides (i.e., the left side and the right side) of horizontal plate of the guiding needle seat and, in the mean time, a guiding groove capable of accommodating said flange is arranged in the main body at an appropriate position corresponding to the said flange and, in addition, a incline guiding angle is arranged at the front end of said flange arranged respectively at the two sides (i.e., the left side and the right side) of the horizontal plate of the guiding needle seat.

3. The structure improvement for connection seat according to claim 1, wherein a recessing groove capable of accommodating LED contact leg is arranged at the front edge of the penetration hole at the top end of the fixation plate of the guiding needle seat according to the invention.
